(19) United States
(12) Patent Application Publication
(10) Pub. No.: US 2019/0347507 A1
(43) Pub. Date: Nov. 14, 2019

(54) MULTI COLOR WRITING TOOL WITH COLOR CAPTURE AND REPLICATION ARRANGEMENT

(71) Applicant: YANGZHONG WANG, WUXI (CN)

(72) Inventor: YANGZHONG WANG, WUXI (CN)

(21) Appl. No.: 16/521,619

(22) Filed: Jul. 25, 2019

(51) Int. Cl. G06K 9/46; B43K 27/08; B43K 5/02; B43K 24/16

(52) U.S. Cl. CPC G06K 9/4652; B43K 24/16; B43K 5/025; B43K 27/08

(57) ABSTRACT

Presented is a smart multi-color writing tool in the form of a pen having a color capture and replication capability, and is equipped with a novel ink dispensing, mixing, and delivery system. The multi color writing tool is configured to capture/scan any colors from variety of objects or images, store the captured colors from the objects or images within a local memory unit configured within the tool or transmit the same to a remotely located computing device, and make use of the captured colors for writing on, marking, or coloring objects, paper, and/or other suitable surfaces.

### TECHNICAL FIELD OF INVENTION

This invention relates generally to multi-color writing tools. More specifically, the present invention relates to a multi-color writing tool such as a pen having a color capture and replication capability. The multi-color writing tool having color capture and replication capability is equipped with a novel ink dispensing, mixing and delivery system configured therein.

### BACKGROUND

Users seek writing tools (such as pen, or pencil) which will write, color, or mark objects with multiple colors. However, finding a right tool that can write in multiple colors is a cumbersome task. Most of the time users need to have multiple tools at their disposal to perform such coloring, writing or marking tasks. While using such multiple tools to fulfil multi-color writing or coloring needs, it is often time consuming for users to identify and select proper tool each time users desire to use a different color.

In the past, few manufacturers have tried to solve this problem by fabricating markers or pens with multiple colored tips, either at one end of the writing markers/pens or at multiple ends. However, such arrangements have proven to be unsatisfactory as the color selection in such tools is limited to only the specific ink provided in the tools, usually two or three discrete colors.

Besides this, in the art, several inventors have envisioned different types of tools for multi-color writing or marking. For example, U.S. Pat. No. 4,692,046 discloses a pen containing multi-color cores located in different tubes housed in the pen body. The colors can be optionally selected for use readily using a specially designed turnable knob having a projected edge in cam contact with the top end of the core-receiving tubes. The top end of the core-receiving tube is pushed down-ward for use, when the turnable knob is rotated to enable a person to select a color core quickly and readily.

Further, US20090257811 discloses a multiple fixed nib writing instrument with improved marking and color selection control. As disclosed in US20090257811, the instrument comprises a barrel that internally contains a plurality of ink reservoirs. The ink reservoirs may each be provided with a different color or shade of ink. Each ink reservoir provides ink only to a respectively connected nib such that each nib can be used to mark in one particular color or shade of ink.

Further, U.S. Pat. No. 9,254,706 discloses a multicolor writing tools including a case member, a cartridge member, a cap member, and an actuator member. The case member forms an interior in which is disposed the cartridge member with the multiple cartridges each of which defines a body containing one of the marking substances therein and a tip through which such a marking substances is applied. The cap member varies and restores at least one configuration thereof, while the actuator member changes the configuration and exposes one of the tips selected by a user out of said interior when the tool is in use, and then restores such a configuration and encloses all of said tips inside the interior when the tool is not in use. Therefore, such writing tools preferably open the cap member in response to input force applied to other parts of the tools by the user, without having to require the user to engage in a separate maneuver to remove the cap member from such tools. In addition, such tools also close the cap member after the use as a response to the cartridge member which retracts into the interior of the case member, without having to require the user to engage in another separate maneuver to place the cap back to the tools. Thus, such tools of the present invention effectively prevent drying of tips of the cartridges when the tool is not in use.

Although several attempts are made in the past to devise multi-color writing tools/instruments. Most of the existing tools include complex mechanical parts. Also selection, dispensing and delivery of ink in such tools are hard to be controlled. Thus, there remains a need for improvement. Thus, the inventor of this invention herein discloses a smart multi-color writing tool having a color capture and replication arrangement, and is equipped with a novel ink dispensing, mixing and delivery system. The proposed multi-color writing tool and the associated mechanism for dispensing, mixing and delivery of ink in the tool is supported by digitization process.

### SUMMARY

Embodiments of the present invention discloses a multi-color writing tool with color capture and replication capability configured for writing on, marking, or coloring objects, paper, and/or other suitable surfaces. The multi-color writing tool with color capture and replication capability may be configured in the form of a marker, a pen, pencil, a coloring tool or the like.

The multi-color writing tool includes an ergonomically designed elongated body adapted to be grasped during use. The elongated body includes a first section having a proximal end, and a distal end. The first section includes at least four ink cartridges removably disposed within the first section near the proximal end, each of the at least four ink cartridges containing a different basic color ink (from CMYK or RGBW color model) for dispensing on the objects, paper, or other suitable surfaces; a color capturing button; and a control circuitry comprising at least a microcontroller unit, a memory unit, and one or more optical sensors, the one or more optical sensors disposed near the distal end and adapted to capture a color from an object or image placed in view of the one or more optical sensors, upon activation of the color capturing button, and the microcontroller unit adapted to receive and process the captured color to derive corresponding basic color values (CMYK color values or RGBW colors values based on type of selected color model). The memory unit is adapted for storage of the captured color from the object or image for future reference or use.

The elongated body further includes a second section having a first end, and a second end, the second end configured to removably receive a writing tip. The second section includes at least four pumps, each connected to the at least four ink cartridges to draw the different basic color ink therefrom, wherein the different basic color ink from the at least four ink cartridges are drawn by the at least four pumps when driven by the microcontroller unit based on the derived basic color values corresponding to the captured color from the object or image; an ink mix compartment in communication with the at least four pumps to receive the different basic color ink from the at least four ink cartridges, the ink mix compartment mixes the received different basic color ink to replicate a color equivalent to the captured color with the corresponding basic color values for writing on, marking, or coloring objects, paper, or other suitable surfaces through the writing tip in communication with the ink mix compartment; and an ink supply button configured to control the dispensing of the replicated color from the ink mix compartment for writing on, marking, or coloring objects, paper, or other suitable surfaces.

According to the embodiment, the first section is either conjoint or removably connected with the second section at the proximal end and the first end of the first section and the second section respectively.

According to the embodiment, the first section further includes a first window detachably configured on outer surface of the first section to facilitate at least selective replacement or removal of the at least four ink cartridges, and display the level of the different basic color ink in the at least four ink cartridges; and a second window configured on the outer surface of the first section to display the captured color from the object or image.

According to the embodiment, the first section further includes an external charging port for selectively charging of an integral power source configured therein for powering the control circuitry.

According to the embodiment, the second section further includes a selector switch configured for use by a user to make a selection of the captured color from the object or image stored in the memory unit in order to replicate the same through the writing tip.

The features and advantages described in this summary and in the following detailed description are not all-inclusive, and particularly, many additional features and advantages will be apparent to one of ordinary skill in the relevant art, in view of the drawings, and specification thereof. Moreover, it should be noted that the language used in the specification has been principally selected for readability and instructional purposes, and may not have been selected to delineate or circumscribe the inventive subject matter.

### BRIEF DESCRIPTION OF DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 shows a front perspective view of a multi-color writing tool, according to an embodiment of the present invention;

FIG. 2 shows a back perspective view of the multi-color writing tool, according to an embodiment of the present invention;

FIGS. 3-5 shows interior environment of the multi-color writing tool of FIG. 1, with the ergonomically designed elongated body removed for the sake of clarity;

FIG. 6 shows a sectional view of the multi-color writing tool of FIG. 1, with the tubes that connect the four ink cartridges with the four pumps, and the tubes that connect the four pumps with the ink mix compartment removed for the sake of clarity; and

FIG. 7 is a block diagram illustrating an exemplary system architecture for the multi-color writing tool, according to a preferred embodiment of the invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

References to “one embodiment”, “an embodiment”, “another embodiment”, “an example”, “another example”, “alternative embodiment”, “some embodiment”, “yet another embodiment”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. Unless stated otherwise, terms such as “first”, “second”, “third”, “fourth”, are used to arbitrarily distinguish between the elements such terms describe. Thus, these terms are not necessarily intended to indicate temporal or other prioritization of such elements.

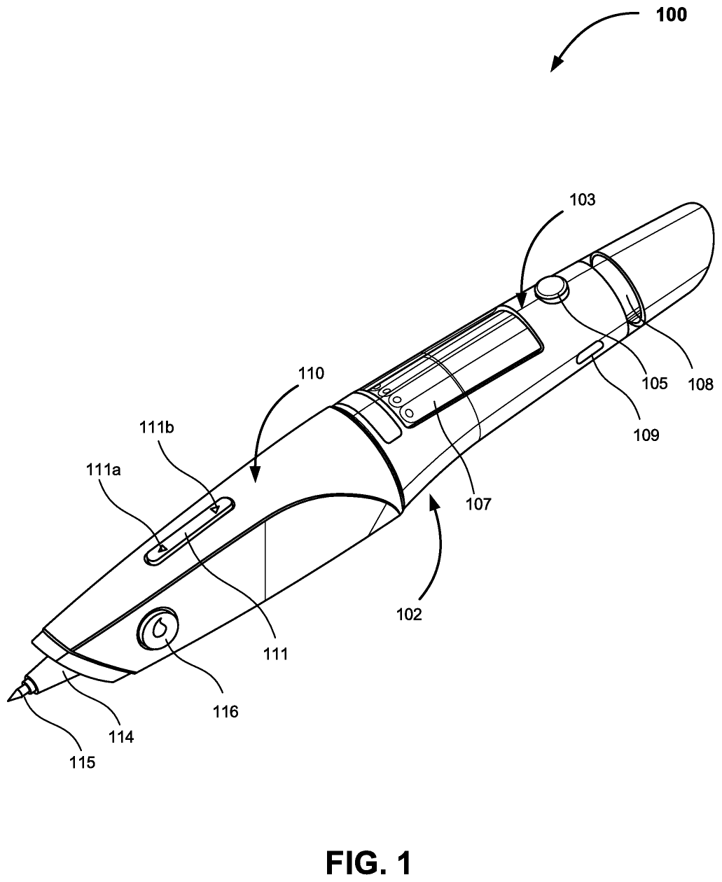

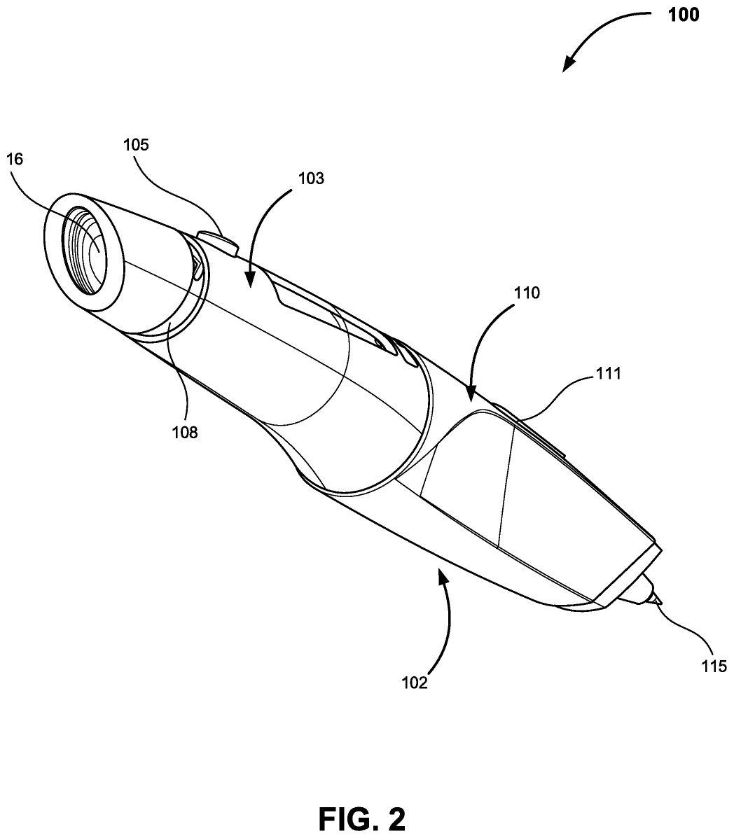

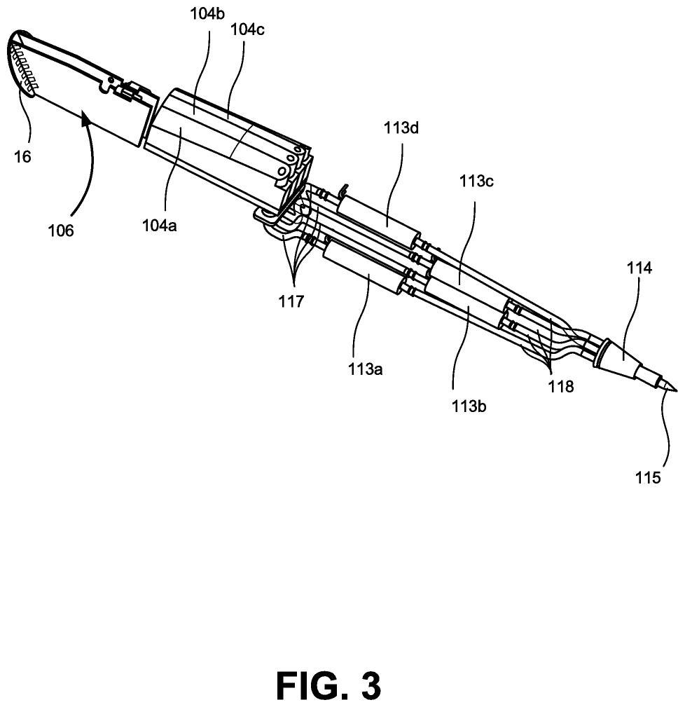

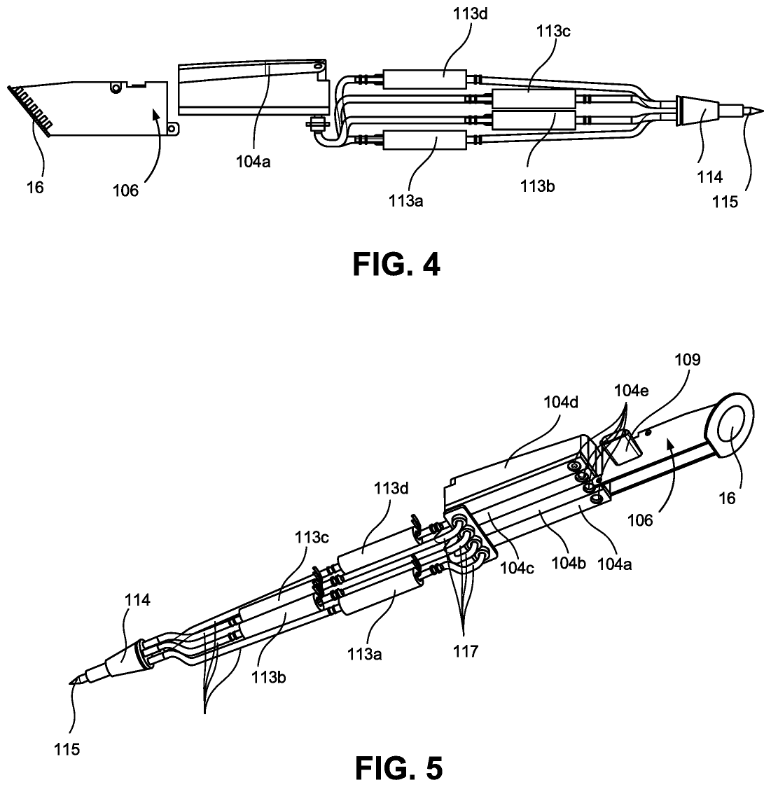

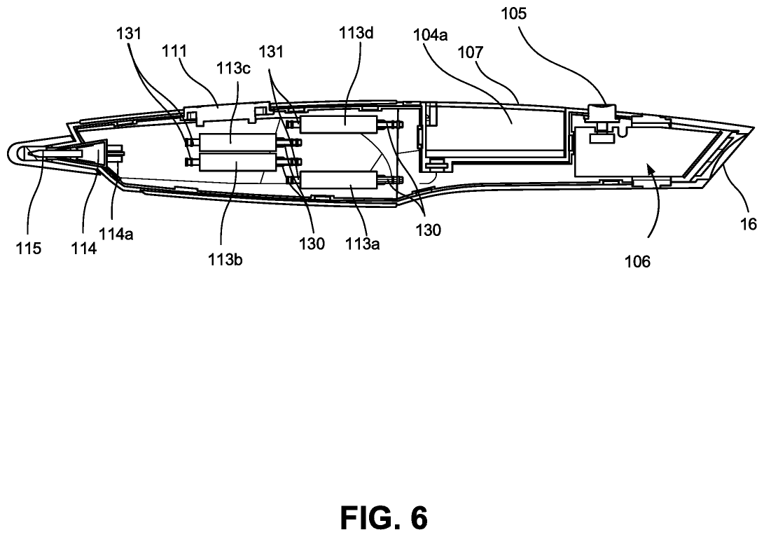

The various features and embodiments of the multi-color writing tool with a color capture and replication capability and a novel ink dispensing, mixing and delivery system will now be better explained in conjunction with FIGS. 1-7.

Referring to FIGS. 1-7, the multi-color writing tool 100 configured for writing on, marking, or coloring objects, paper, and/or other suitable surfaces using multiple colors captured by the tool 100 includes an ergonomically designed elongated body 102 adapted to be grasped during use of the tool 100. The elongated body 102 is preferably made rigid in a pen shaped.

The elongated body 102 includes a first section 103, and a second section 110. The first section 103 includes a proximal end, and a distal end. The second section 110 includes a first end, and a second end. According to the embodiment, the first section 103 is either conjoint or removably connected with the second section 110 at the proximal end of the first section 103 and the first end of the second section 110.

According to the embodiment, the first section 103 includes at least four ink cartridges, such as the ink cartridges 104a-104d that are either fixedly disposed or removably disposed within the first section 103 of the tool 100 near the proximal end. Each of the ink cartridges 104a-104d contains a different basic color ink. The different basic color ink are either selected from a CMYK color model or a RGBW color model. The different basic color ink may be in different forms but not limited to gel like ink, a pigmented ink, a dye ink, a fluorescent ink, In an example, when the different basic colors are selected from CMYK color model then each of the cartridges 104a-104d will include Cyan (C), Magenta (M), Yellow (Y), Black (K) (or CMYK) color ink for dispensing desired color onto the objects, paper, or other suitable surfaces when the tool 100 is used to write on, or mark or color the objects, paper, and/or other suitable surfaces. In another example, when the different basic colors are selected from RGBW color model then each of the cartridges 104a-104d will include Red (R), Green (G), Blue (B), White (W) (or RGBW) color ink for dispensing desired color onto the objects, paper, or other suitable surfaces when the tool 100 is used to write on, or mark or color the objects, paper, and/or other suitable surfaces The first section 103 of the elongated body 102 further includes a window 107 detachably configured on an outer surface of the first section 103 to facilitate selective replacement or removal of the ink cartridges 104a-104d (especially when the cartridges 104a-104d are removably disposed within the section 103), or facilitate refilling of the ink cartridges 104a-104d (especially when the cartridges 104a-104d are fixedly disposed within the section 103) and display the level of the different color ink in the ink cartridges 104a-104d. The window 107 is configured such that the user can easily detach the window 107, in order to replace one or more of the ink cartridges 104a-104d with the new ones or refill the existing one or more of the ink cartridges 104a-104d. The window 107 is made transparent in order to serve the purpose of displaying the level of the different basic color ink (from CMYK color model or RGBW color model) in each of the four ink cartridges 104a-104d.

According to the embodiment, each of the ink cartridges 104a-104d is further provided with one or more air ventilation filter 104e configured to facilitate the different basic color ink from the ink cartridges 104a-104d to flow to the pumps 113a-113d, when the pumps 113a-113d are activated to draw the basic color ink therefrom. In operation, these air ventilation filters 104e allow air to get into the ink cartridges 104a-104d (opposed to leakage of any ink from the ink cartridges 104a-104d) that pushes the basic color ink into the pumps 113a-113d during the operation of the tool 100.

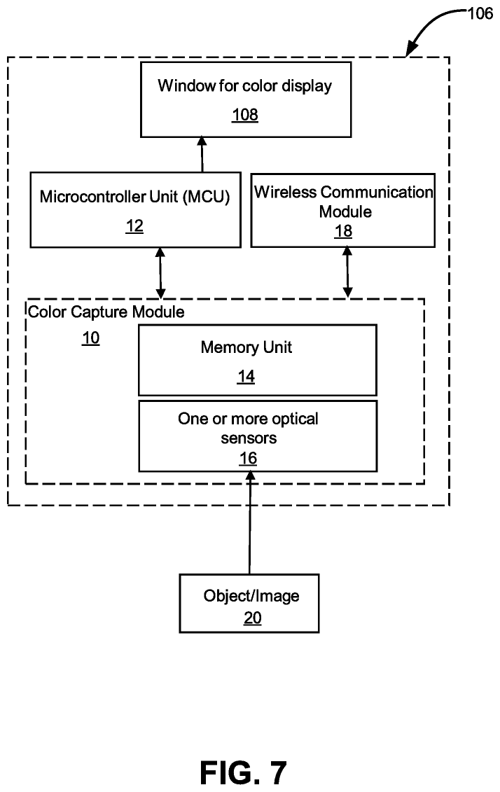

According to the embodiment, the first section 103 further includes a control circuitry 106. The control circuitry 106 includes at least a microcontroller unit 12, a memory unit 14, and one or more optical sensors or image sensors 16 (as shown in FIG. 7). For the purpose of this application, the image sensors 16 and the memory unit 14 together is also referred to as a color capture module 10. In an example, the microcontroller unit 12, the memory unit 14, and the one or more optical sensors 16 are mounted on a Printed Circuit Board (PCB) and are operationally connected with one another, using the known techniques, communication means known in the art in order to serve the desired purpose.

The optical sensors 16 of the color capture module 10 are preferably disposed at the base of the PCB near the distal end of the first section 103. These image sensors/optical sensors 16 are adapted to capture a color from an external object or image 20 placed in view of the optical sensors 16. The examples for the objects and images 20 that can be brought near the view of the optical sensors 16 are infinite, for example, a flower, a leaf, and so on. The operation of the optical sensors 16 is triggered upon activation of the color capturing button 105 by a user. In particular, when the user desires to capture a color from an external object or image 20, the user need to press and release the button 105 to scan the color from the object 20. The time lapse for capturing of the color from the object 20 is short (some milliseconds). According to the embodiment, the tool 100 is also configured to generate a beep sound or other sounds of like nature to confirm successful capturing of the color from the object 20. Further, the tool 100 is also provided with a window 108 configured on an outer surface of the first section 103 of the elongated body 102 to display the captured color from the object or image 20.

The microcontroller unit 12 of the control circuitry 106 in communication with the color capture module 10 is adapted to receive and process the captured color from the color capture module 10 to derive corresponding basic color values. These basic color values derived by the microcontroller unit 12 may also be stored in the memory unit 14 for future reference or use. These stored captured colors with specific basic color values can later be viewed or used by the user for writing, or marking or coloring different surfaces such as a paper. The multi-color writing tool 100 is provided with a selector switch 111 (configured over the second section 110 as shown in FIG. 1) for use by the user to make a selection of the captured color stored in the memory unit 14 in order to replicate the same color through the writing tip 115 of the tool 100. The selector switch 111 is provided with a forward button 111a and a backward button 111b that help the user navigate through the captured colors stored in the memory unit 14. Upon selection of the desired color from the memory unit 14, the selected color becomes available for view on the window 108 for the user to confirm the selection. Further, there may be generation of the beep sound to confirm the color selection from the user. Further, there is provided a wireless communication module 18, such as but not limited to Bluetooth, and Wi-Fi. The wireless communication module 18 may either be configured as a part of control circuitry 106 mounted on the PCB or may be configured separately in a way to communicate with the color capture module 10 in order to transmit the stored colors (with specific basic color values) to a remote computing device (such as a laptop, and a phone) wirelessly for further uses. For example, there might be some Image processing application such as ADOBE PHOTOSHOP™ installed on some computing device and the user might need to make use of the captured colors stored in the memory unit 14 of the tool 100 for use with the application. The wireless communication module 18 helps the user transmit the stored colors from the tool 100 to the application so that the same can be used by the user with the application for various purposes.

As seen in FIG. 1, the first section 103 further includes an external charging port 109 for selectively charging of an integral power source configured within the section 103. The integral power source may preferably include one or more batteries for powering the control circuitry 106. In the preferred embodiment, the batteries may be rechargeable in nature so that the user can make use of an external charger to charge the tool 100 through the port 109.

Further, according to the embodiment, the second section 110 (of the elongated body 102) having the first end, and the second end includes a writing tip 115 removably configured at the second end. The removability feature for the writing tip 115 is advantageous and helps the user to use variety of tips such as a round water color tip, a sharp water color tip, a ball point tip, a pen tip, a mark pen tip, and a brush tip based on user's need.

The second section 110 further includes at least four pumps, such as the pumps 113a-113d. The pumps 113a-113d may be of different types known in the art, preferably but not limited to a solenoid valve, an electromagnetic pump and a piezoelectric pump. Each of the pumps 113a-113d will have two connecting ends and may be configured to communicate with the PCB or the control circuitry 106. Each of the pumps 113a-113d is connected to respective ink cartridges 104a-104d to draw the different basic color ink (either from CMYK colors or RGBW colors) stored in each of the ink cartridges 104a-104d. For example, the pump 113a may be connected to the ink cartridge 104a, the pump 113b to the cartridge 104b and so on. The different basic color ink from the ink cartridges 104a-104d containing ink from CMYK color model or RGBW color model are drawn by the respective four pumps 113a-113d. The amount and type of the basic color inks that would be drawn from the cartridges 104a-104d to the pumps 113a-113d depend upon the derived basic color values of the captured color or captured color stored in the memory unit 14. The pumps 113a-113d are configured to draw the different basic color ink from the respective cartridges 104a-104d when driven by the microcontroller unit 12 based on the derived basic color values (determined by the microcontroller unit 12) corresponding to the captured color from the object or image 20. For example, a specific captured color or stored color in the memory unit may have CMYK values as 10 pulses of C, 15 pulses of M, 20 pulses of Y, 12 pulses of K. In this situation, the four pumps 113a-113d will draw 10 pulses of C, 15 pulses of M, 20 pulses of Y, 12 pulses of K from respective cartridges 104a-104d in order to assist in replication of the desired captured color. According to the embodiment, each of the ink cartridges 104a-104d is connected to each of the pumps 113a-113d using a first set of tubes 117 that allow the different basic color ink to flow from the ink cartridges 104a-104d to the pumps 113a-113d. These first set of tubes 117 connect the cartridges 104a-104d to one end 130 of the pumps 113a-113d.

The second section 110 further includes at least one an ink mix compartment 114 in communication with the four pumps 113a-113d to receive different basic color inks that the pumps 113a-113d draw from the ink cartridges 104a-104d. The ink mix compartment 114, upon receiving the different basic color inks from the pumps 113a-113d mixes the different basic color ink to replicate a color equivalent to the captured color with the corresponding basic color values for writing on, marking, or coloring objects, paper, or other suitable surfaces through the writing tip 115 configured to be in communication with the ink mix compartment 114. The writing tip 115 according to the invention may be replaceable and be of different sizes so that the user based on his need, replace one writing tip 115 with the other.

Further, each of the pumps 113a-113d is connected to the ink mix compartment 114 using a second set of tubes 118 (similar to or different than the tubes 117) that allow the different basic color ink to flow from the pumps 113a-113d to the ink mix compartment 114 for mixing in order to facilitate replication of desired color ink. These second set of tubes 118 connect one end 114a of the ink mix compartment 114 to other end 131 of the pumps 113a-113d.

According to the embodiment, the second section 110 is further provided with an ink supply button 116 configured to control flow of or dispensing of the replicated color from the ink mix compartment 114 for writing on, marking, or coloring objects, paper, or other suitable surfaces. According to the embodiment, when continuously pressed, the ink supply button 116 is configured to allow dispensing of the replicated color onto the objects, paper, or other suitable surfaces through the writing tip 115 and when depressed, configured to restrict dispensing of the replicated color onto the objects, paper, or other suitable surfaces through the writing tip 115.

It should be noted that, the multi-color writing tool and any associated components, parts thereof described above in FIGS. 1-6 with respect to various embodiments may be made of different suitable materials known in the art, and be made in different shapes and sizes that may make the presented invention realization in real scenario. It is also possible that different parts or components of the invention may be made of different materials and thus use of material should not be considered as any limitation to the implementation of the present invention.

The preceding description has been presented with reference to various embodiments. Persons skilled in the art and technology to which this application pertains will appreciate that alterations and changes in the described structures and methods of operation can be practiced without meaningfully departing from the principle, spirit and scope of the present invention.

What is claimed is:

1. A multi-color writing tool (100) with color capture and replication capability configured for writing on, marking, or coloring objects, paper, and/or other suitable surfaces, comprising:
an ergonomically designed elongated body (102) adapted to be grasped during use, the elongated body (102) comprising:
a first section (103) having a proximal end, and a distal end, the first section (103) comprising:
at least four ink cartridges (104a-104d) disposed within the first section (103) near the proximal end, each of the at least four ink cartridges (104a-104d) containing a different basic color ink for dispensing on the objects, paper, or other suitable surfaces;
a color capturing button (105);
a control circuitry (106) comprising at least a microcontroller unit (12), a memory unit (14), and one or more optical sensors (16), the one or more optical sensors (16) disposed near the distal end and adapted to capture a color from an object or image (20) placed in view of the one or more optical sensors (16), upon activation of the color capturing button (105), and the microcontroller unit (12) adapted to receive and process the captured color to derive corresponding basic color values; and
a second section (110) having a first end, and a second end, the second end configured to removably receive a writing tip (115), the second section comprising:
at least four pumps (113a-113d), each connected to the at least four ink cartridges (104a-104d) to draw the different basic color ink therefrom, wherein the different basic color ink from the at least four ink cartridges (104a-104d) are drawn by the at least four pumps (113a-113d) when driven by the microcontroller unit (12) based on the derived basic color values corresponding to the captured color from the object or image (20);
an ink mix compartment (114) in communication with the at least four pumps (113a-113d) to receive the different basic color ink from the at least four ink cartridges (113a-113d), the ink mix compartment (114) mixes the received different basic color ink to replicate a color equivalent to the captured color with the corresponding basic color values for writing on, marking, or coloring objects, paper, or other suitable surfaces through the writing tip (115) in communication with the ink mix compartment (114); and
an ink supply button (116) configured to control the dispensing of the replicated color from the ink mix compartment (114) for writing on, marking, or coloring objects, paper, or other suitable surfaces.

2. The multi-color writing tool (100) of claim 1, wherein the memory unit (14) is adapted for storage of the captured color from the object or image (20) for future reference or use.

3. The multi-color writing tool (100) of claim 1, wherein the first section (103) is conjoint with the second section (110) at the proximal end and the first end of the first section (103) and the second section (110) respectively.

4. The multi-color writing tool (100) of claim 1, wherein the first section (103) is removably connected with the second section (110) at the proximal end and the first end of the first section (103) and the second section (110) respectively.

5. The multi-color writing tool (100) of claim 1, wherein the first section (103) further comprising:
a first window (107) detachably configured on outer surface of the first section (103) to facilitate at least one of:
selective replacement or removal of the at least four ink cartridges (104a-104d),
refilling of the at least four ink cartridges (104a-104d), and
display the level of the different basic color ink in the at least four ink cartridges (104a-104d); and
a second window (108) configured on the outer surface of the first section (103) to display the captured color from the object or image (20).

6. The multi-color writing tool (100) of claim 1, wherein the different basic color ink contained in each of the at least four ink cartridges (104a-104d) is selected from at least a CMYK (Cyan-Magenta-Yellow-Black) color model, or a RGBW (Red-Green-Blue-White) color model.

7. The multi-color writing tool (100) of claim 1, wherein the color values corresponding to the captured color correspond to at least the values for Cyan (C), or Magenta (M), or Yellow (Y), or Black (K) color ink in the CMYK color model, or Red (R), or Green (G), or Blue (B), or White (W) color ink in the RGBW color model.

8. The multi-color writing tool (100) of claim 1, wherein the writing tip (115) configured on the second end of the second section (110) is selected from a group consisting of a round tip, a sharp color tip, a ball point tip, a pen tip, a marker pen tip, and a brush tip.

9. The multi-color writing tool (100) of claim 16, wherein the different basic color ink contained in each of the at least four ink cartridges (104a-104d) is selected from a group consisting of a gel like ink, a pigmented ink, a dye ink, and a fluorescent ink.

10. The multi-color writing tool (100) of claim 1, wherein the first section (103) further comprising an external charging port (109) for selectively charging of an integral power source configured therein for powering the control circuitry (106).

11. The multi-color writing tool (100) of claim 1, wherein the second section (110) further comprising a selector switch (111) configured for use by a user to make a selection of the captured color from the object or image (20) stored in the memory unit (14) in order to replicate the same through the writing tip (115).

12. The multi-color writing tool (100) of claim 11, wherein the selector switch (111) is provided with a forward button (111a) and a backward button (111b) that help navigate through the captured color from the object or image (20) stored in the memory unit (14).

13. The multi-color writing tool (100) of claim 1, wherein the at least four pumps (113a-113d) are selected from a group consisting of a solenoid valve, an electromagnetic pump, and a piezoelectric pump.

14. The multi-color writing tool (100) of claim 1, wherein the ink supply button (116), when continuously pressed allows dispensing of the replicated color onto the objects, paper, or other suitable surfaces through the writing tip (115).

15. The multi-color writing tool (100) of claim 1, wherein the ink supply button (116), when depressed restricts dispensing of the replicated color onto the objects, paper, or other suitable surfaces through the writing tip (115).

16. The multi-color writing tool (100) of claim 1, wherein each of the at least four ink cartridges (104a-104d) comprising an air ventilation filter (104e) configured to facilitate the different basic color ink from the at least four ink cartridges (104a-104d) to flow to the at least four pumps (113a-113d).

17. The multi-color writing tool (100) of claim 1, wherein the first section (103) further comprising a wireless communication module (18) disposed therein, and in communication with a color capture module (10) of the control circuitry (106) for transmitting the captured color stored in the memory unit (14) to a remote computing device wirelessly.

18. The multi-color writing tool (100) of claim 1, wherein each of the at least four ink cartridges (104a-104d) is connected to each of the at least four pumps (113a-113d) using a first set of tubes (117) that allow the different basic color ink to flow from the at least four ink cartridges (104a-104d) to the at least four pumps (113a-113d).

19. The multi-color writing tool (100) of claim 1, wherein each of the at least four pumps (113a-113d) is connected to the ink mix compartment (114) using a second set of tubes (118) that allow the different basic color ink to flow from the at least four pumps (113a-113d) to the ink mix compartment (114) for mixing in order to facilitate replication of desired color ink.
